(19) United States
(12) Patent Application Publication
(10) Pub. No.: US 2023/0095215 A1
(43) Pub. Date: Mar. 30, 2023

(54) MITIGATING IMPACT OF BROKEN WEB LINKS

(71) Applicant: INTERNATIONAL BUSINESS MACHINES CORPORATION, ARMONK, NY (US)

(72) Inventors: Nixon Cheaz, Cary, NC (US); Rosemary Lucille Ray, Cary, NC (US); Partho Ghosh, Kolkata (IN); Sergio Escalante, Raleigh, NC (US)

(21) Appl. No.: 17/448,554

(22) Filed: Sep. 23, 2021

(51) Int. Cl. G06F 16/955; G06F 16/958; G06F 16/9535; G06F 16/2457; G06K 9/00

(52) U.S. Cl. CPC G06F 16/9566; G06F 16/958; G06F 16/9535; G06F 16/24578; G06K 9/00456; G06K 2209/01

(57) ABSTRACT

A computer-implemented method, a computer system and a computer program product mitigate the impact of broken web links. The method includes receiving a web link request from a source website. The web link request includes a broken URL. The method also includes determining an intent of the web link request. In addition, the method includes selecting a relevant substitute webpage, wherein the relevant substitute webpage includes an address, based on the determined intent. Lastly, the method includes routing the web link request to the address of the relevant substitute webpage.

### BACKGROUND

Embodiments relate generally to improving the Internet web browsing experience, and more specifically to mitigating the impact of broken web links on the experience of browsing the web through redirection to relevant substitute pages.

As the Internet becomes a primary method of commerce and gathering information, commercial websites may become a primary form of connection between businesses and consumers. Typically, commercial websites may consist of a large amount of both static and dynamic content such as Hypertext Markup Language (HTML) items, images, graphics or logos, audio and video files and other applications. Because of the rapidly changing nature of this environment, website content may change location or be removed in an instant, which may put a premium on flexibility for systems that use these resources. Minimizing frustration for users and mitigating the impact of broken web links on an online reputation of a business, e.g., the credibility of a website that may claim to be fully updated, may be critical in navigating an Internet economy.

### SUMMARY

An embodiment is direct to a computer-implemented method for mitigating an impact of broken web links. The method may include receiving a web link request from a source website. The web link request includes a broken URL. The method may also include determining an intent of the web link request. The method may further include selecting a relevant substitute webpage based on the determined intent. The relevant substitute webpage may include an address. Lastly, the method may include routing the web link request to the address of the relevant substitute webpage.

In an embodiment, the method may include storing the determined intent as metadata associated with the broken URL.

In another embodiment, selecting the relevant substitute webpage may include generating a set of search parameters based on the intent of the web link request and may also include performing a search of a website using the generated set of search parameters. In this embodiment, selecting the relevant substitute webpage may further include retrieving search results. The search results may include substitute webpages and a relevance score and may be ranked by the relevance score. Lastly, in this embodiment, selecting the relevant substitute webpage may include selecting the substitute webpage with the highest relevance score as the relevant substitute webpage in response to the relevance score being above a threshold.

In a further embodiment, determining the intent of the web link request may include capturing text data from the source website. The text data may be assigned a priority by whether the text data is within a specific distance from the web link request on the source website. In this embodiment, determining the intent of the web link request may also include scanning the text data with a text recognition algorithm and a natural language processing algorithm and generating an intent of the web link request based on the scanned text data and the assigned priority.

In yet another embodiment, determining the intent of the web link request may include obtaining an image from the source website, scanning the image using optical character recognition or object recognition, and generating an intent of the web link request based on the scanned image.

In another embodiment, determining the intent of the web link request may include monitoring user interactions with the source website and generating an intent of the web link request based on the user interactions.

In a further embodiment, determining the intent of the web link request may include using a machine learning classification model to predict the intent of the web link request.

In addition to a computer-implemented method, additional embodiments are directed to a system and a computer program product for mitigating the impact of broken web links.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts a block diagram of a computing system that may be used to request access to a webpage using a broken web link and be redirected to a relevant substitute webpage according to an embodiment.

FIG. 3 depicts a flow chart diagram for a process to mitigate the impact of broken web links according to an embodiment.

FIG. 4 depicts a block diagram of the inputs and machine learning model of a process to determine an intent of a web link request and generate a list of potential substitute web pages according to an embodiment.

FIG. 5 depicts a cloud computing environment according to an embodiment.

FIG. 6 depicts abstraction model layers according to an embodiment.

### DETAILED DESCRIPTION

Commercial Web sites may consist of a large amount of static and dynamic content such as Hypertext Markup Language (HTML) content, pictures, graphics, sound and video files, and Web applications. Due to the rapid and frequent changes to website content, typically on a daily basis, websites have to be modified accordingly in order to reflect the most up to date information. Such modifications include changing and relocating the content of the HTML, picture, graphics, audio, and video files, and deleting the old static and/or dynamic files.

Because website content changes rapidly and frequently, even with very simple websites, it may be difficult to completely identify every reference, e.g., hyperlinks and the like, to content that has changed or relocated. Moreover, at present, Web browsers and Web servers may not have any way to know from a reference whether website content may be obsolete or no longer accessible. Such obsolete references are typically referred to as “broken links.”

For example, a file may be initially located at one Uniform Resource Locator (URL) but during maintenance, directory restructuring or other similar process, the file corresponding to this URL may be moved to a new location with a new URL. If a user has saved the original URL and then tries to access the original URL after the file has been moved, an error page known as a “404 error”, for example, may be generated and returned to the user’s Web browser client application. Similarly, if the user clicks on a link that redirects to the original URL, a similar error page may be generated.

Receiving such error pages repeatedly may become frustrating to users of web browsers since they do not provide any information for the user to find the desired web content and the user cannot proceed any further. In a typical application, to avoid such error pages being presented to users attempting to access Web content, website providers may be forced to manually create a redirect method or provide a variety of error feedback mechanisms, such as a redirect to a generic top-level page of a website or a page listing and explaining error types. None of these mechanisms allow a user to immediately access the desired Web content. Rather, the user may be forced to go through a number of operations to attempt to correct the error and find the Web content for which they are looking.

As a result of the ineffectiveness of these mechanisms, Web browser users may not achieve the users’ goals of accessing the desired Web content and become confused and frustrated and possibly do not return to the offending website. At the same time, the website provider may not meet the needs of their desired customers and website objectives and may possibly hurt their overall image and “brand loyalty,” as well as overall business revenue, by not identifying all broken links in their Web sites.

As an improvement to existing methods, it may be advantageous to, among other things, implement a system, i.e., a “smart handler,” to automatically prevent a request for a non-existent page by redirecting a user to an alternative page that is more relevant and also more likely to meet the needs of the user than using standard methods. Such a smart handler may be a feature on a web site that may step in when a non-existent page is requested, i.e., a broken link is followed. It may perform introspection by looking at the source of the link, e.g., the “referrer URL,” and may learn the intent of the user in clicking on the broken link. Such a smart handler may determine the intent by examining a combination of key concepts on the source page, the location of the link on the source page, and also the meaning of text that surrounds the broken link on the source page. This intent may be used to search for existing relevant web pages so that a “404 error” may be avoided by automatically redirecting the user to the alternative page, thus improving the user’s web browsing experience and eliminating the frustration and loss of reputation that may come with the “404 error” pages.

In addition, such a smart handler may also enable pages and links to incorporate a “meta trace” that may describe key components of the page or meta data or multifarious intents, etc. Such a meta trace may be added to the generated page link as metadata to be used as query, or hash, parameters when searching for a substitute webpage to the link to the page so that if the page subsequently moves or is removed, these parameters for the page’s link may contain information to more easily find a suitable alternative or enable the smart handler that has been described.

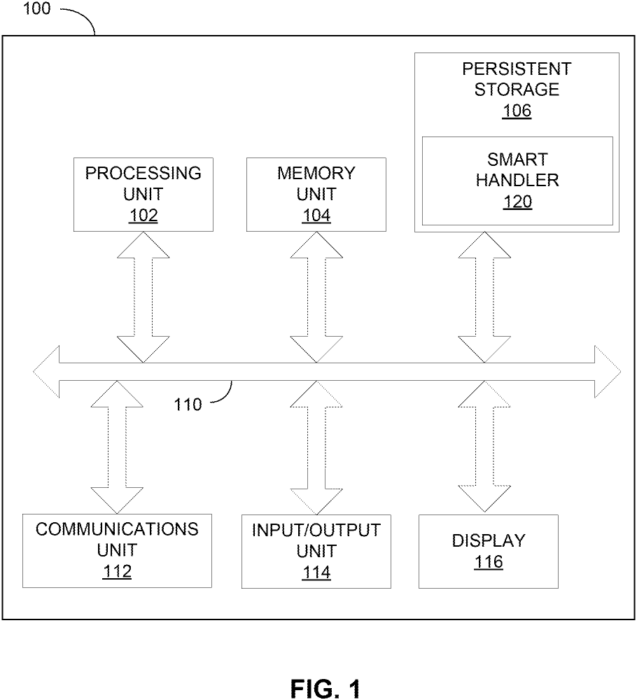

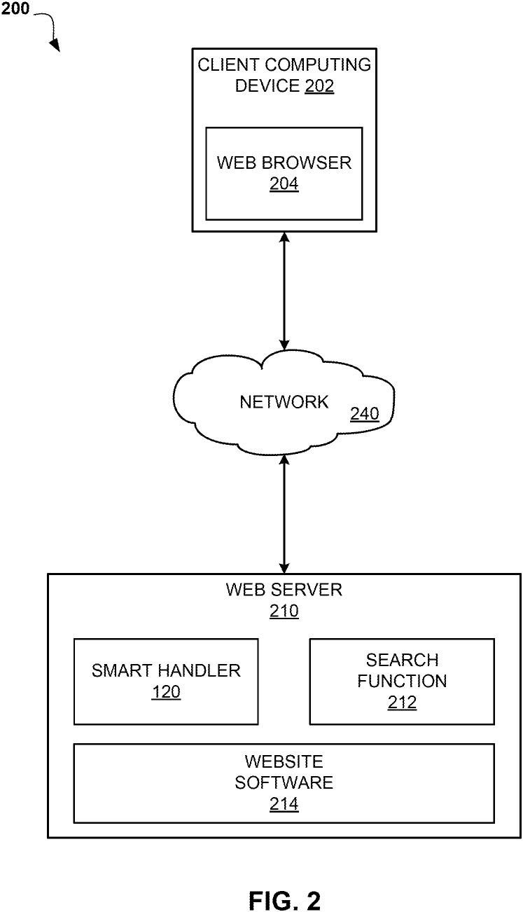

Referring now to FIG. 1, a block diagram is depicted illustrating a computer system 100 which may be embedded in the client computing device 202 and/or the web server 210 depicted in FIG. 2 in accordance with an embodiment. It should be appreciated that FIG. 1 provides only an illustration of one implementation and does not imply any limitations with regard to the environments in which different embodiments may be implemented. Many modifications to the depicted environments may be made based on design and implementation requirements.

As shown, a computer system 100 includes a processor unit 102, a memory unit 104, a persistent storage 106, a communications unit 112, an input/output unit 114, a display 116, and a system bus 110. Computer programs such as the smart handler 120 or web browser 204 are typically stored in the persistent storage 106 until they are needed for execution, at which time the programs are brought into the memory unit 104 so that they can be directly accessed by the processor unit 102. The processor unit 102 selects a part of memory unit 104 to read and/or write by using an address that the processor unit 102 gives to memory unit 104 along with a request to read and/or write. Usually, the reading and interpretation of an encoded instruction at an address causes the processor unit 102 to fetch a subsequent instruction, either at a subsequent address or some other address. The processor unit 102, memory unit 104, persistent storage 106, communications unit 112, input/output unit 114, and display 116 interface with each other through the system bus 110.

Examples of computing systems, environments, and/or configurations that may be represented by the data processing system 100 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Each computing system 100 also includes a communications unit 112 such as TCP/IP adapter cards, wireless Wi-Fi interface cards, or 3G or 4G wireless interface cards or other wired or wireless communication links. The web browser 204 in the client computing device 202 and the smart handler 120 in the web server 210 may communicate with external computers via a network (for example, the Internet, a local area network or other wide area network) and respective network adapters or interfaces, e.g., communications unit 112. From the network adapters or interfaces, the web browser 204 in the client computing device 202 and the smart handler 120 in the web server 210 are loaded into the respective persistent storage 106. The network may comprise copper wires, optical fibers, wireless transmission, routers, firewalls, switches, gateway computers and/or edge servers.

Referring to FIG. 2, an example 200 is shown of a user requesting access to a webpage using a broken web link, e.g., a link to a webpage that no longer exists or has been moved to a new location, and then being redirected to a relevant substitute webpage according to an embodiment. The networked computer environment 200 may include a client computing device 202 and one or more web servers 210, interconnected via a communication network 240. According to at least one implementation, the networked computer environment 200 may include a plurality of client computing devices 202 and a plurality of web servers 210 but only one of each type of device is shown for illustrative brevity.

The communication network 240 may include various types of communication networks, such as a wide area network (WAN), local area network (LAN), a telecommunication network, a wireless network, a public switched network and/or a satellite network. The communication network 240 may include connections, such as wire, wireless communication links, or fiber optic cables. It may be appreciated that FIG. 2 provides only an illustration of one implementation and does not imply any limitations with regard to the environments in which different embodiments may be implemented. Many modifications to the depicted environments may be made based on design and implementation requirements. Accordingly, the communication network 240 may represent any communication pathway between the various components of the networked computer environment 200.

Client computing device 202 may include a web browser 204 displaying a website and configured to communicate with the web server 210 via the communication network 240, in accordance with an exemplary embodiment. The web browser 204 may provide a user interface in which a user utilizing the client computing device 202 may enter an address manually or click on a link and navigate to a website, represented in FIG. 2 as website software 214, according to the exemplary embodiments. Client computing device 202 may be, for example, a mobile device, a telephone, a personal digital assistant, a netbook, a laptop computer, a tablet computer, a desktop computer, or any type of computing device capable of running a program and accessing a network. The client computing device 202 may include computing system 100 shown in FIG. 1.

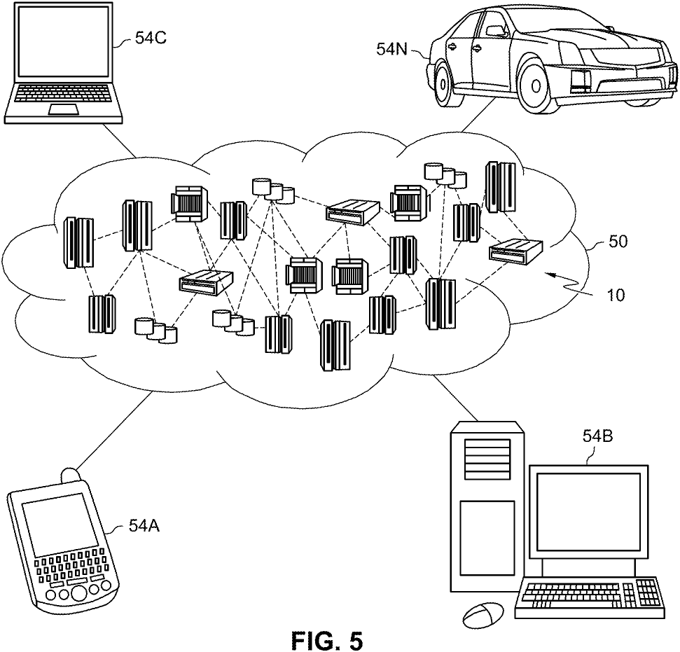

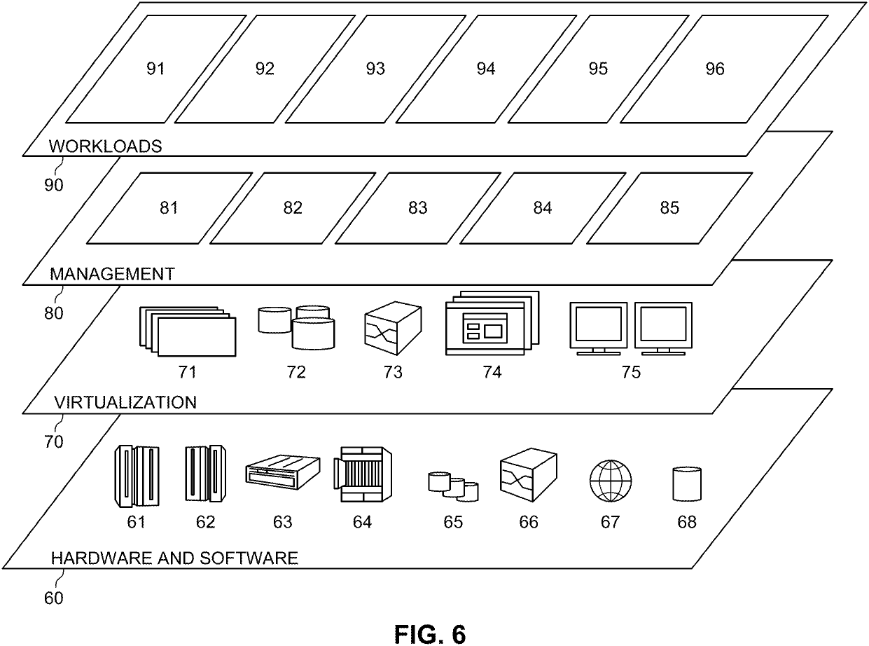

The web server 210 may be a laptop computer, netbook computer, personal computer (PC), a desktop computer, or any programmable electronic device or any network of programmable electronic devices capable of hosting and running search function 212 and website software 214. In the embodiment of FIG. 2, smart handler 120 may be embedded within the website software 214 or be configured to be loaded (and run) on web server 210 separately from website software 214. The search function 212 may be configured to receive search input from a user via the web browser 204 or may receive search terms from the smart handler 120. The search function 212 may be configured to process the search terms that it receives and may return a ranked list of search results, with the rank determined by the relevancy of the results to the search terms provided. The web server 210 may communicate with the client computing device 202 via the communication network 240, in accordance with embodiments of the invention. As discussed above, the web server 210 may include computing system 100. As will be discussed with reference to FIGS. 5 and 6, the web server 210 may also operate in a cloud computing service model, such as Software as a Service (SaaS), Platform as a Service (PaaS), or Infrastructure as a Service (IaaS). The web server 210 may also be located in a cloud computing deployment model, such as a private cloud, community cloud, public cloud, or hybrid cloud.

In the example 200, a user may use web browser 204 on client computing device 202 to navigate to a website, e.g., connect to website software 214, on web server 210. While connected to website software 214, the user may attempt to navigate to another site of interest or, perhaps, to get more information about what is displayed on the website. This may be accomplished by clicking on a web link or entering a manual address that may be displayed on the website. In the example of FIG. 2, the address of the web link may be broken as the destination site may have been removed or changed location. In this case, the smart handler 120 may intervene and prevent an error from being sent to the web browser 204 and also analyze the web link to determine the intent of the user. This may include using text recognition in tandem with natural language processing (NLP) algorithms to determine the context of the web page, such as the title of the page or a general topic of the page. The smart handler 120 may also focus more closely on the text that is closest in proximity to the web link on the website by applying a weight to any decisions or classifications that may be returned from that text specifically. The smart handler 120 may also analyze user interactions with the website such as mouse clicks or text that may be entered into the website to determine intent. The determined intent of the user may be used by the smart handler 120 to enter search terms into search function 212 to find relevant substitute webpages that meet the user’s determined intent. The search function 212 may return results that are ranked by relevance, i.e., the closest match to the search terms, and therefore the user’s intent would be at the top and have the highest relevance score as assigned by the search function 212. As an example of search function 212, if a user is intending to retrieve information about a specific product on a company website and the web link refers to an obsolete product name or part number, that company’s website may have the needed information to route the user to a suitable webpage. The smart handler 120 may apply a threshold to these ranked results such that any webpage in the results must have a minimum relevance to the user’s intent. The smart handler 120 may then send the address of the highest-ranked substitute webpage to the web browser 204 and the user may be routed directly to a working webpage that is closest in content to what was intended, without knowing that the web link that was followed was a broken link.

One of ordinary skill in the art will recognize that while FIG. 2 depicts a search function 212 integrated into the web server 210, this component may not be necessary to the process of locating relevant substitute webpages. For instance, smart handler 120 may contact an external search engine integrated into a separate search server to find relevant webpages to satisfy the user’s need.

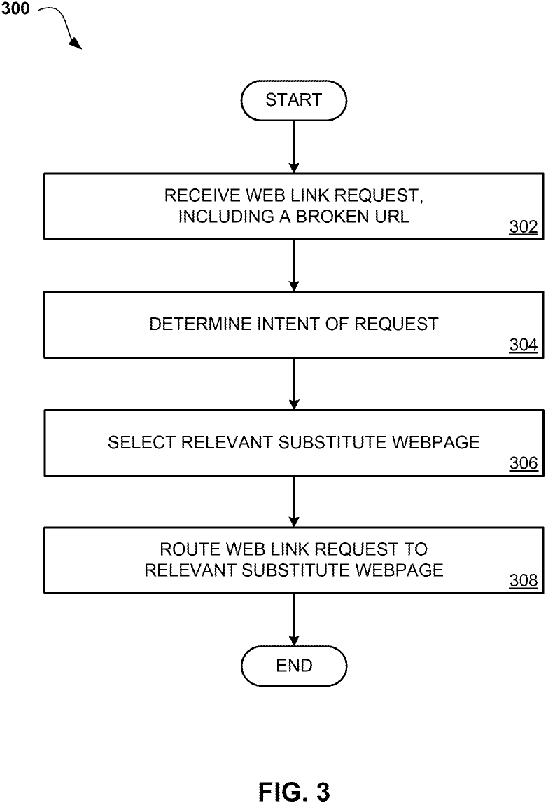

Referring to FIG. 3, an operational flowchart illustrating a process 300 for mitigating the impact of broken web links is depicted according to at least one embodiment. At 302, a request to link to a website may be received from a referring webpage. For example, a user may click on a text link or an image that contains a link on the referring webpage and the link may have an address or URL for another website to which the user may want to be redirected. Alternatively, a user may manually type in an address to the user’s web browser on the client computing device to be taken directly to a specific website. If the web link request includes a functioning address, then no action is necessary. However, if the web link request is broken, i.e., the address or URL in the request is not functional because the destination webpage has moved or is no longer in service, the process 300 may move to step 304.

At 304, an intent of the web link request received in 302 may be determined. To accomplish this, context may be gathered from the referring webpage and increasing weight or focus may be put on the information and text that may be located closest in proximity to the web link that was clicked on to create the request received in 302. For example, a user may be navigating a web site that explains a technology that a company employs in its products or services and the user may want more details on certain aspects of the technology and may click on a link to learn more. The context of the webpage may be the name and overview of the technology, such as “distributed ledger” or “hybrid cloud.” However, because the user may have clicked on a link about a specific aspect of the technology, it may be useful to place more weight or focus on the text that is closest to where the link was clicked in order to more precisely determine the user’s intent. This may be accomplished by configuring a minimum distance from the link that was clicked on and assigning a priority to text that falls within this configured minimum distance. It should be noted, as discussed below, that any collection of user data, including but not limited to mouse clicks, requires the user’s prior consent.

In addition to text on the referring webpage, images on the referring webpage may also be inspected using an appropriate optical character recognition algorithm or an object recognition algorithm to identify information that may also contribute to determining the intent of the web link request. Just as with the text, a priority may be assigned to images within a configured minimum distance from the site of the web link. Again, this proximity to the web link may indicate more clearly the intent of the user in clicking on the web link, i.e., the intent of the web link request.

Many types of methods and technologies may be used to determine the intent of the web link request. A non-exhaustive list may include determining the context of the removal or deletion of the URL related to the web link, e.g., the amount of time that the target website has been down or the circumstances of the link being broken such as scheduled maintenance or a permanent deletion. Webpage metrics such as results of prior attempts to access the desired URL or other webpage metadata or the text that was clicked may be checked. In addition, mouse interactions of the user with the source website prior to clicking on the web link and making the request may be tracked to determine a context of the user at the moment of the event when a broken link is clicked or launched in a new browser tab or referenced in any document. For example, a user may be researching products with specific technology, which may indicate that they are looking for a specific product offering on the target website.

In an embodiment, a supervised machine learning classification model may be trained to predict intent of a web link request. One or more of the following machine learning algorithms may be used: logistic regression, naive Bayes, support vector machines, deep neural networks, random forest, decision tree, gradient-boosted tree, multilayer perceptron, and one-vs-rest. In an embodiment, an ensemble machine learning technique may be employed that uses multiple machine learning algorithms together to assure better prediction when compared with the prediction of a single machine learning algorithm. In this embodiment, training data for the model may include past interactions with a specific website using certain web links. The training data may include mouse click interactions or text recognition and natural language processing results and may be collected from a single user or a group of users, with user consent required prior to collection of any training data. In this embodiment, the classification results may be stored in a database so that the data is most current, and the output would always be up to date.

At 306, once an intent of the web link request has been determined, a relevant substitute webpage may be selected from potential substitute webpages that may be generated and ranked by a relevance score. To accomplish this, the intent of the web link request may be converted into a set of search terms to be entered in an internal website search function, e.g., search function 212 or an external search engine. The results of the search may be the set of potential substitute webpages that may be ranked and sorted by a relevance score that may be assigned by the search function. The relevance score may be determined by the logic of the search function but at the same time, a fixed threshold may be applied such that any results that may be considered suitable have a minimum relevance to the intent. One of ordinary skill in the art will recognize that there are many alternative ways to search for relevant webpages. It is only required that the determined intent serve as input to a search routine that may return a list of possible substitute webpages as search results, along with assigned relevance scores. The threshold may then be applied to the results and if the relevance score is above the threshold, i.e., the minimum relevance to the original address is at least met, the highest-ranked search result, or the substitute webpage with the highest relevance score that is above the threshold, may be used for the next step in the process, where the web link request may be redirected to the address of the highest-ranked substitute web page. In a similar way, if the relevance scores of all the results do not meet or exceed the threshold, that fact may be passed to the next step in the process and, as explained in 308, an error message may be passed to the user.

From a determined intent and corresponding set of search terms, many various techniques may be used to select a relevant substitute webpage. For instance, one approach may be to use an existing search application in the corporate web site. These search applications are customarily standard features for commercial web sites and are usually comprised of at least the basic core components that make up a modern search stack: a search engine, a search index populated with the content of the web site, an API to make search queries using keywords and intent, and optionally but commonly, a machine learning model that refines the relevance of the search results.

At 308, if a relevant substitute webpage has been selected, i.e., the top-ranked search result is above the threshold that was used, the web link request may be routed to the relevant substitute webpage automatically. This may be accomplished by replacing the address of the broken link with the address of the selected webpage and may be done without prompting by the user or any system, which allows the user to be seamlessly taken to the substitute webpage without the knowledge that the original web link had a broken URL. Even though the actual routing to the substitute webpage may be automatic and transparent to a user, this step may also include gathering feedback from the user after the fact to determine if the webpage to which the user has been routed, and therefore the substitute webpage that was selected in 306, is, in fact, the most relevant substitute webpage. Such feedback may be used as training data for the machine learning model and refine future predictions of user intent in clicking web links.

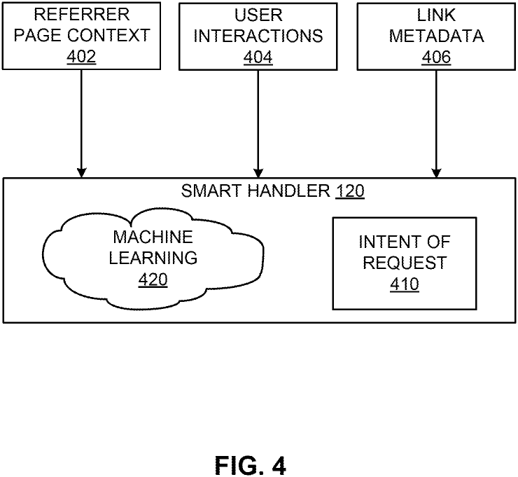

Referring now to FIG. 4, a diagram showing examples of components or modules of a process to determine an intent of a web link request and generate a list of potential substitute web pages is depicted according to at least one embodiment. According to one embodiment, the process may include smart handler 120 which may utilize supervised machine learning 420 to determine an intent of a web link request 410, e.g., the user’s intent when clicking on the web link, based on a context of the webpage where the request was made, especially with respect to text or objects that are in close physical proximity to the link. A pattern of user interactions such as mouse clicks or any explicit choices made by a user in relation to making the web link request may also be used in the machine learning model, along with potential link metadata that may have been added, e.g., text that may have been added to a link if it was already the subject of an analysis for a broken web link. The supervised machine learning model may use any appropriate machine learning algorithm, e.g., Support Vector Machines (SVM) or random forests. The smart handler 120 may refer to the source website itself, i.e., the referrer webpage, to determine a context 402, which is any text or object on the referrer web page that may indicate the user’s intent. For example, the heading of the referrer webpage may indicate a topic that may be used to infer what the user may be trying to find. Special attention may be paid to text and objects that may be in close proximity to the web link that was clicked to focus the search for a substitute webpage. For instance, even if a topic is known, the user may be looking for specific information such as a product that uses certain technology that the referrer webpage talks about generally. An image of specific products may be close to the link or the link may be the image itself. In this situation, the image would be of particular assistance in determining the intent of the web request 410.

Another potential input to the machine learning model is user interactions 404 with the source website and other websites through the web browser 204 that may be monitored. User interactions 404 are most commonly mouse clicks or another way to make an explicit choice of one of the search results but one of ordinary skill in the art will recognize that there are many ways for the machine learning model to collect information from the client computing device 202 about a user’s browsing history or track a user’s movements on the client computing device around the time that a web link request is made.

It is also important to note that any monitoring and collection of data related to human users as mentioned herein, such as capturing a user’s mouse clicks or other interactions or tracking a user’s presence online, requires the informed consent of all those people whose data is captured for analysis. Consent may be obtained in real time or through a prior waiver or other process that informs a subject that their data may be captured by certain devices, e.g., software on a client computing device 202 or web server 210 or any other computing device that may be connected to the network 240, or that other sensitive personal data may be gathered through any means and that this data may be analyzed by any of the many algorithms that may be implemented herein. A user may opt out of any portion of the monitoring at any time.

Another possible way to learn the intent of a web link request 410 may be to scan link metadata 406 that may be associated with the broken link. As mentioned above, the smart handler 120 may append text, e.g., a “meta trace”, to the link as metadata to assist when a link may be once again broken, and an analysis and search need to be undertaken to determine a relevant substitute webpage. The smart handler 120 may use all of the above inputs, i.e., referrer page context 402, user interactions 404 and link metadata 406, to determine an intent of the web link request 410 for an implementation and also may store and update a database to remember every intent of a web link request 410 found in the process. In addition, the smart handler 120 may obtain explicit feedback from a user once an intent is determined and a relevant substitute webpage is selected. Such feedback may be used as training data for the machine learning model, as mentioned above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66, such as a load balancer. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and smart handler 96, which may refer to a module for mitigating the impact of broken web links through redirection to relevant substitute webpages.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for mitigating an impact of broken web links comprising:
receiving a web link request from a source website, wherein the web link request includes a broken URL associated with an inactive webpage;
determining a context for a removal of the inactive webpage from metadata associated with the broken URL;
identifying an intent of a user in current browsing activity of the user at the source website;
selecting a substitute webpage based on the identified intent of the user and the context for the removal, wherein the substitute webpage includes an address; and
routing the web link request to the address of the substitute webpage.

2. The computer-implemented method of claim 1, further comprising storing the identified intent of the user with the metadata associated with the broken URL.

3. The computer-implemented method of claim 1, wherein the selecting the substitute webpage comprises:
generating a set of search parameters based on the identified intent of the user ;
performing a search of a website using the a generated set of search parameters;
retrieving search results, wherein each search result comprises a webpage and a relevance score;
ranking the search results by the relevance score; and
selecting the substitute webpage when the relevance score is above a threshold, wherein the substitute webpage has a highest relevance score.

4. The computer-implemented method of claim 1, wherein the identifying the intent of the user in the current browsing activity of the user at the source website further comprises:
capturing text data from the source website during the current browsing activity of the user at the source website, wherein the text data is assigned a priority when the text data is within a specific distance from a location on the source website that initiated the web link request;
scanning the text data with a text recognition algorithm and a natural language processing algorithm; and
generating an intent of the user based on the scanned text data and the an assigned priority.

5. The computer-implemented method of claim 1, wherein the identifying the intent of the user in the current browsing activity of the user at the source website further comprises:
obtaining an image from the source website during the current browsing activity of the user at the source website;
scanning the image using optical character recognition or object recognition; and
generating an intent of the user based on the a scanned image.

6. The computer-implemented method of claim 1, wherein the identifying the intent of the user in the current browsing activity of the user at the source website further comprises:
monitoring user interactions with the source website during the current browsing activity of the user at the source website; and
generating an intent of the user based on the user interactions.

7. The computer-implemented method of claim 1, wherein a machine learning classification model that predicts user intent from web browsing activity is used to identify the intent of the user in the current browsing activity of the user at the source website .

8. A computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
receiving a web link request from a source website, wherein the web link request includes a broken URL associated with an inactive webpage;
determining a context for a removal of the inactive webpage from metadata associated with the broken URL;
identifying an intent of a user in current browsing activity of the user at the source website;
selecting a substitute webpage based on the identified intent of the user and the context for the removal, wherein the substitute webpage includes an address; and
routing the web link request to the address of the substitute webpage.

9. The computer system of claim 8, further comprising storing the identified intent of the user with the metadata associated with the broken URL.

10. The computer system of claim 8, wherein the selecting the substitute webpage comprises:
generating a set of search parameters based on the identified intent of the user ;
performing a search of a website using the a generated set of search parameters;
retrieving search results, wherein each search result comprises a webpage and a relevance score;
ranking the search results by the relevance score; and
selecting the substitute webpage when the relevance score is above a threshold, wherein the substitute webpage has a highest relevance score.

11. The computer system of claim 8, wherein the identifying the intent of the user in the current browsing activity of the user at the source website further comprises:
capturing text data from the source website during the current browsing activity of the user at the source website, wherein the text data is assigned a priority when the text data is within a specific distance from a location on the source website that initiated the web link request;
scanning the text data with a text recognition algorithm and a natural language processing algorithm; and
generating an intent of the user based on the scanned text data and the an assigned priority.

12. The computer system of claim 8, wherein the identifying the intent of the user in the current browsing activity of the user at the source website further comprises:
obtaining an image from the source website during the current browsing activity of the user at the source website;
scanning the image using optical character recognition or object recognition; and
generating an intent of the user based on the a scanned image.

13. The computer system of claim 8, wherein the identifying the intent of the user in the current browsing activity of the user at the source website further comprises:
monitoring user interactions with the source website during the current browsing activity of the user at the source website; and
generating an intent of the user based on the user interactions.

14. The computer system of claim 8, wherein a machine learning classification model that predicts user intent from web browsing activity is used to identify the intent of the user in the current browsing activity of the user at the source website .

15. A computer program product comprising:
a computer readable storage device having program instructions embodied therewith, the program instructions executable by a processor to cause the processor to perform a method comprising:
receiving a web link request from a source website, wherein the web link request includes a broken URL associated with an inactive webpage;
determining a context for a removal of the inactive webpage from metadata associated with the broken URL;
identifying an intent of a user in current browsing activity of the user at the source website;
selecting a substitute webpage based on the identified intent of the user and the context for the removal, wherein the substitute webpage includes an address; and
routing the web link request to the address of the substitute webpage.

16. The computer program product of claim 15, further comprising storing the identified intent of the user with the metadata associated with the broken URL.

17. The computer program product of claim 15, wherein the selecting the substitute webpage comprises:
generating a set of search parameters based on the identified intent of the user ;
performing a search of a website using the a generated set of search parameters;
retrieving search results, wherein each search result comprises a webpage and a relevance score;
ranking the search results by the relevance score; and
selecting the substitute webpage when the relevance score is above a threshold, wherein the substitute webpage has a highest relevance score.

18. The computer program product of claim 15, wherein the identifying the intent of the user in the current browsing activity of the user at the source website further comprises:
capturing text data from the source website during the current browsing activity of the user at the source website, wherein the text data is assigned a priority when the text data is within a specific distance from a location on the source website that initiated the web link request;
scanning the text data with a text recognition algorithm and a natural language processing algorithm; and
generating an intent of the user based on the scanned text data and the an assigned priority.

19. The computer program product of claim 15, wherein the identifying the intent of the user in the current browsing activity of the user at the source website further comprises:
monitoring user interactions with the source website during the current browsing activity of the user at the source website; and
generating an intent of the user based on the user interactions.

20. The computer program product of claim 15, wherein a machine learning classification model that predicts user intent from web browsing activity is used to identify the intent of the user in the current browsing activity of the user at the source website .
